(19) United States
(12) Patent Application Publication
(10) Pub. No.: US 2020/0326201 A1
(43) Pub. Date: Oct. 15, 2020

(54) IN-VEHICLE APPARATUS, INFORMATION PROVISION SYSTEM, AND INFORMATION PRESENTATION METHOD

(71) Applicants: Clarion Co., Ltd., Saitama-shi, Saitama (JP); KISHI MIRAI INC., Yokohama-shi, Kanagawa (JP)

(72) Inventors: Norikazu NARA, Saitama-shi (JP); Noriyuki ABE, Saitama-shi (JP); Makoto ORINO, Hitachi-shi (JP); Takaaki YASHIRO, Hitachi-shi (JP); Toshihiro MOCHIZUKI, Saitama-shi (JP); Norimasa KISHI, Yokohama-shi (JP)

(21) Appl. No.: 16/772,735

(22) PCT Filed: Dec. 7, 2018
(86) PCT No.: PCT/JP2018/045165

§ 371 Date: Jun. 12, 2020

(30) Foreign Application Priority Data
Dec. 14, 2017 (JP) 2017-240003

(51) Int. Cl. G01C 21/36; G06F 3/14

(52) U.S. Cl. CPC G01C 21/3676; G06F 3/14; H04W 4/48; G01C 21/3682; G01C 21/3617

(57) ABSTRACT

An in-vehicle apparatus mounted in a vehicle includes: a travel history database in which a travel history of the vehicle is recorded with respect to each road; and a display control unit that has a display unit display a map screen, wherein the display control unit has the display unit display each road included within a display range of the map screen in a display form according to a travel frequency of the vehicle on the basis of the travel history database.

### TECHNICAL FIELD

The present invention relates to an in-vehicle apparatus, an information provision system, and an information presentation method.

### BACKGROUND ART

There has been conventionally known a navigation apparatus for recording a history of roads where a vehicle traveled in the past, and displaying a map based on the recorded history of roads. PTL 1 mentioned below discloses a navigation apparatus that: overlays and displays a searched route on a map displayed on a display device; and displays the existence of an unrecognized road in a specific manner, that is, in such a manner that the existence of the unrecognized road can be identified if the unrecognized road where a vehicle has never traveled exists in road sections constituting each searched route as a result of judgment based on a movement history information group.

### CITATION LIST

### Patent Literature

PTL 1: Japanese Patent Application Laid-Open (Kokai) Publication No, 2014-228389

### SUMMARY OF THE INVENTION

### Problems to be Solved by the Invention

With the navigation apparatus disclosed in PTL 1, only roads which constitute the searched road are displayed based on the past travel history. Therefore, regarding roads other than the searched route even if such roads exists within a display range of the map, the user cannot be informed of with what degree of frequency the vehicle traveled on the relevant roads in the past.

### Means to Solve the Problems

An in-vehicle apparatus according to the present invention is mounted in a vehicle and includes: a travel history database in which a travel history of the vehicle is recorded with respect to each road; and a display control unit that has a display unit display a map screen, wherein the display control unit has the display unit display each road included within a display range of the map screen in a display form according to a travel frequency of the vehicle on the basis of the travel history database.

An information provision system according to the present invention is equipped with an in-vehicle apparatus mounted in a vehicle, and a server, wherein the in-vehicle apparatus includes: an in-vehicle communication control unit that receives a travel history of the vehicle with respect to each road, wherein the travel history is transmitted from the server; and a display control unit that has a display unit display a map screen, and wherein the server includes: a travel history database in which a travel history of a plurality of vehicles including the vehicle is recorded with respect to each road; and a server communication control unit that transmits the travel history of the vehicle with respect to each road on the basis of the travel history database, wherein the display control unit has the display unit display each road included within a display range of the map screen in a display form according to a travel frequency of the vehicle on the basis of the travel history.

An information presentation method according to the present invention records a travel history of a vehicle with respect to each road and has a display unit mounted in the vehicle display a map screen indicating each road in a display form according to a travel frequency of the vehicle on the basis of the travel history.

### Advantageous Effects of the Invention

According to the present invention, the user can be informed of the past travel frequency of the roads existing within the display range of the map.

### BRIEF DESCRIPTION OF DRAWINGS

FIG. 1 is a configuration diagram of an information provision system according to one embodiment of the present invention;

FIG. 2 is a configuration diagram of an in-vehicle apparatus and a server according to one embodiment of the present invention;

FIG. 3 is a diagram illustrating a data structure example of a travel history DB;

FIG. 4 is a flowchart illustrating actions of the in-vehicle apparatus in the information provision system according to a first embodiment of the present invention;

FIG. 5 is a flowchart of road display decision processing;

FIG. 6 is a diagram illustrating an example of a map screen according to the first embodiment of the present invention;

FIG. 7 is a flowchart illustrating actions of the in-vehicle apparatus in the information provision system according to a second embodiment of the present invention;

FIG. 8 is a diagram illustrating an example of a map screen according to the second embodiment of the present invention;

FIG. 9 is a flowchart of road display decision processing according to a third embodiment of the present invention;

FIG. 10 is a diagram illustrating an example of color-coding and displaying roads via a HUD or projection mapping.

### DESCRIPTION OF EMBODIMENTS

### First Embodiment

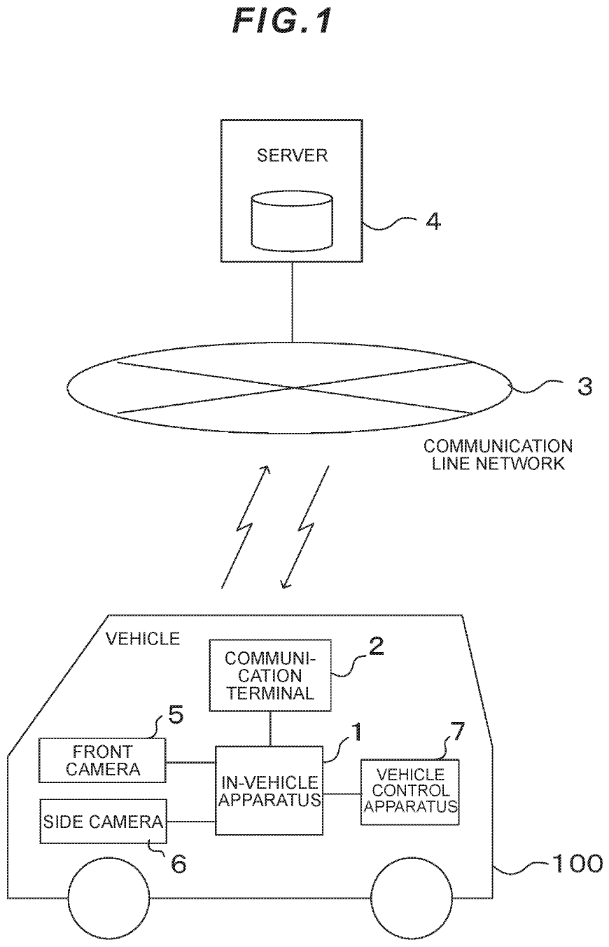

A first embodiment of the present invention will be explained with reference to the drawings. FIG. 1 is a configuration diagram of an information provision system according to one embodiment of the present invention. The information provision system illustrated in FIG. 1 is designed to provide a user who rides in a vehicle 100 with various information according to a traveling status of the vehicle 100 and is configured of an in-vehicle apparatus 1 and a communication terminal 2, which are mounted in the vehicle 100, a communication line network 3, and a server 4. Incidentally, the in-vehicle apparatus 1 and the communication terminal 2 are connected via wired or wireless connection.

The in-vehicle apparatus 1 displays a map screen and provides the user, who is a driver of the vehicle 100, with map information. The in-vehicle apparatus 1 is connected to: a front camera 5 and a side camera 6 which are mounted in the vehicle 100, respectively, facing the front side and the lateral side of the vehicle 100; and a vehicle control apparatus 7 that performs various processing and control relating to traveling of the vehicle 100. The vehicle control apparatus 7 is, for example, an ECU (Electronic Control Unit) and the vehicle 100 is equipped with various types of vehicle control apparatuses depending on their functions and control objects.

The communication terminal 2 wirelessly connects to the communication line network 3 as necessary under control of the in-vehicle apparatus 1. The communication line network 3 is connected to the server 4. Specifically, the in-vehicle apparatus 1 can communicate with the server 4 by connecting to the server 4 via the communication terminal 2 and the communication line network 3. When the communication terminal 2 and the communication line network 3 are connected wirelessly, wireless base stations which the communication line network 3 has and which are not illustrated in the drawing are used. These wireless base stations can wirelessly communicate with the communication terminal 2 located within their surrounding specified communication areas, and are installed at various locations. Incidentally, the communication terminal 2 is, for example, a mobile phone. Furthermore, the communication line network 3 is constructed by, for example, a mobile phone network or the Internet.

The server 4 stores a travel history of the vehicle 100. The in-vehicle apparatus 1 can estimate a travel route of the vehicle 100 and provide the user with the information by downloading the travel history of the vehicle 100 from the server 4.

Incidentally, FIG. 1 illustrates an example where one in-vehicle apparatus 1 mounted in one vehicle 100 is connected to the server 4; however, practically; in-vehicle apparatuses respectively mounted in a large number of vehicles are connected to the server 4 and each in-vehicle apparatus provides their user with information. In this embodiment, actions of one in-vehicle apparatus 1 among them will be explained as a representative example, but other in-vehicle apparatuses operate in the same manner.

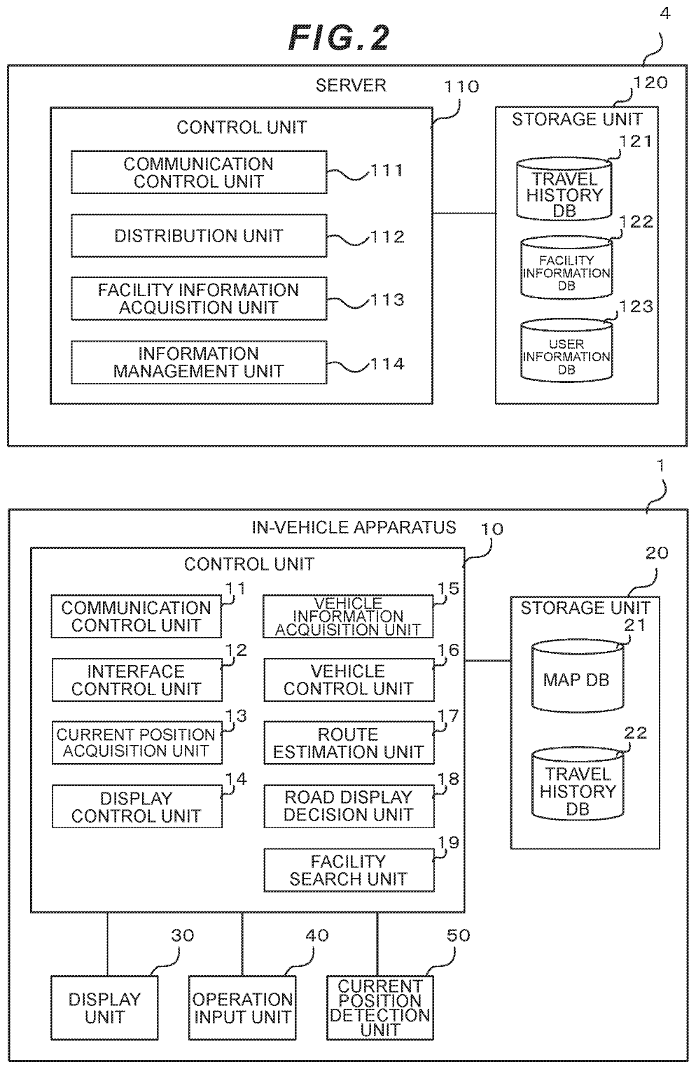

FIG. 2 is a configuration diagram of the in-vehicle apparatus 1 and the server 4 according to one embodiment of the present invention. The in-vehicle apparatus 1 includes, as illustrated in FIG. 2, a control unit 10, a storage unit 20, a display unit 30, an operation input unit 40, and a current position detection unit 50. The server 4 includes a control unit 110 and a storage unit 120.

The control unit 10 for the in-vehicle apparatus 1 is configured of a CPU, a ROM, a RAM, and so on which are not illustrated in the drawing and performs various processing and arithmetic operations to operate the in-vehicle apparatus 1. The control unit 10 has, as its functions, the respective functional blocks of a communication control unit 11, an interface control unit 12, a current position acquisition unit 13, a display control unit 14, a vehicle information acquisition unit 15, a vehicle control unit 16, a route estimation unit 17, a road display decision unit 18, and a facility search unit 19. The control unit 10 can implement these functional blocks by, for example, decompressing programs, which are stored in the ROM, in the RAM and having the CPU execute the programs. Incidentally, the details of these functional blocks possessed by the control unit 10 will be explained later.

The storage unit 20 is a nonvolatile storage medium and is configured by using, for example, an HDD (hard disk drive), an SSD (solid state drive), or a memory card. The storage unit 20 includes a map DB 21 which is a database formed with various information relating to maps, for example, information such as positions, connections, shapes, widths, and the number of lanes of roads and information such as landforms, city names, area names, and various facilities (POI: Point of Interest) on the map. Specifically speaking, map information for displaying a map screen on the in-vehicle apparatus 1 is stored as the map DB 21 in the storage unit 20. Furthermore, the storage unit 20 includes a travel history DB 22 which indicates a travel history of the vehicle 100. Incidentally, some or all of programs executed by the CPU in the control unit 10 may be stored in the storage unit 20.

The display unit 30 displays various images and videos according to control of the display control unit 14. The display unit 30 is configured by using, for example, a liquid-crystal display.

The operation input unit 40 accepts operation input from the user and outputs operation information to the control unit 10 according to the operation content. The operation input unit 40 is configured of, for example, a touch panel and various kinds of switch groups which are integrated with the display unit 30.

The current position detection unit 50 detects a current position of the vehicle 100, that is, a current position of the user who is riding in the vehicle 100 and outputs the detection result to the control unit 10. The current position detection unit 50 is configured by using, for example, a GPS sensor. Incidentally, when the GPS sensor is used as the current position detection unit 50, the current position based on a GPS signal may be calculated at the control unit 10. The current position of the vehicle 100 (the current position of the user) detected by the current position detection unit 50 will be hereinafter simply referred to as the “current position,”

The control unit 110 for the server 4 is configured of a CPU, a ROM, a RAM, and so on which are not illustrated in the drawing and performs various processing and arithmetic operations to operate the server 4. The control unit 110 has, as its functions, the respective functional blocks of a communication control unit 111, a distribution unit 112, a facility information acquisition unit 113, and an information management unit 114. The control unit 110 can implement these functional blocks by, for example, decompressing programs, which are stored in the ROM, in the RAM and having the CPU execute the programs. Incidentally, the details of these functional blocks possessed by the control unit 110 will be explained later.

The storage unit 120 is a nonvolatile storage medium and is configured by using, for example, an HDD (hard disk drive), an SSD (solid state drive), or a memory card. The storage unit 120 includes: a travel history DB 121 which is a database formed of travel histories of a large number of vehicles including the vehicle 100 connected to the server 4; a facility information DB 122 which is a database formed of facility information about various facilities at different places; and a user information DB 123 which is a database of user information about users of the respective in-vehicle apparatuses. Incidentally, some or all of programs executed by the CPU in the control unit 110 may be stored in the storage unit 120.

Next, the respective functional blocks of the control unit 10 for the in-vehicle apparatus 1 and the control unit 110 for the server 4 will be explained.

The communication control unit 11 controls the communication terminal 2 when the in-vehicle apparatus 1 communicates with the server 4 via the communication terminal 2 and the communication line network 3. The in-vehicle apparatus 1 can transmit and receive information to and from the server 4 by controlling the communication terminal 2 using the communication control unit 11.

The interface control unit 12 performs interface control when the in-vehicle apparatus 1 communicates with the front camera 5, the side camera 6, and the vehicle control apparatus 7, respectively. The in-vehicle apparatus 1 communicates with the front camera 5, the side camera 6, and the vehicle control apparatus 7, respectively, via the interface control performed by the interface control unit 12 and can thereby acquire captured images output from the front camera 5 and the side camera 6 and issue action instructions to the vehicle control apparatus 7.

The current position acquisition unit 13 acquires the current position detection result from the current position detection unit 50.

The display control unit 14 has the display unit 30 display the map screen by using the map DB 21 stored in the storage unit 20. This map screen displays each road included within a display range in a display form according to the travel frequency of the vehicle 100 and also displays information of facilities which exist in an area(s) with a low travel frequency and match the user's taste. Incidentally, a specific example of the map screen displayed on the display unit 30 by the display control unit 14 will be explained later. Moreover, the display control unit 14 can provide the user with, for example, images indicating the ambient environment of the vehicle 100, which are generated based on the captured images acquired from the front camera 5 and the side camera 6, by having the display unit 30 display such images.

The vehicle information acquisition unit 15 acquires various vehicle information about the traveling status of the vehicle 100. The vehicle information acquired by the vehicle information acquisition unit 15 includes, for example, the captured images which are output from the front camera 5 and the side camera 6 and control information which is output from the vehicle control apparatus 7. The vehicle information acquisition unit 15 can acquire these pieces of vehicle information via the interface control unit 12.

The vehicle control unit 16 controls the traveling status of the vehicle 100 by issuing an action instruction to the vehicle control apparatus 7 on the basis of, for example, map information around the current position acquired from the map DB 21 and the vehicle information acquired by the vehicle information acquisition unit 15. Automatic driving of the vehicle 100 is implemented by this action of the vehicle control unit 16. Incidentally, the vehicle control unit 16 can issue the action instruction to the vehicle control apparatus 7 via the interface control unit 12.

The route estimation unit 17 estimates a travel route for the vehicle 100 to travel from now on the basis of the map DB 21 and the travel history DB 22. Incidentally, a history of routes where the vehicle 100 traveled in the past is recorded on a link string basis in the travel history DB 22. The route estimation unit 17 can: estimate the destination where the user is headed by referring to this travel history DB 22; and predict a travel route for the vehicle 100 from the current position to the destination.

The road display decision unit 18 decides the display form of each road on the map screen displayed on the display unit 30 by the display control unit 14 on the basis of the travel history DB 22. Incidentally, a method for deciding the display form of each road by the road display decision unit 18 will be explained later.

The facility search unit 19 searches for a facility/facilities that matches/match specified conditions on the basis of the map DB 21. For example, the facility search unit 19 searches for information about the facility/facilities that exists/exist in areas with a low travel frequency of the vehicle 100 and matches/match the user's taste. The facility search result by the facility search unit 19 is indicated on the map screen displayed on the display unit 30 by the display control unit 14 and is thereby presented to the user.

The communication control unit 111 performs communication control which is required when the server 4 communicates with the in-vehicle apparatus 1 via the communication terminal 2 and the communication line network 3. The communication control unit 111 performs, for example, interface processing between the server 4 and the communication line network 3 upon the communication control.

The distribution unit 112 distributes information which is recorded in the travel history DB 121 in response to a distribution request from the in-vehicle apparatus 1. For example, when receiving a distribution request for the travel history of the vehicle 100 from the in-vehicle apparatus 1, the distribution unit 112 identifies the user of the in-vehicle apparatus 1 based on the user information DB 123, acquires the travel history of the vehicle 100 corresponding to the relevant user from the travel history DB 121, and distributes it to the in-vehicle apparatus 1. Furthermore, when receiving a distribution request for facility information about a newly-registered facility from the in-vehicle apparatus 1, the distribution unit 112 acquires the facility information which has not been distributed to the in-vehicle apparatus 1 from among the facility information registered in the facility information DB 122, from the facility information DB 122 and distributes the acquired facility information to the in-vehicle apparatus 1. Incidentally, when the distribution unit 112 distributes the information to the in-vehicle apparatus 1, the communication control unit 111 is used to perform communication between the server 4 and the in-vehicle apparatus 1.

The facility information acquisition unit 113 acquires the facility information about various facilities from an external server, which is not illustrated in the drawing, and accumulates the acquired facility information in the facility information DB 122. Incidentally, when the facility information acquisition unit 113 acquires the facility information from the external server, the server 4 communicates with the external server via a communication line such as the Internet.

The information management unit 114 manages information stored in the storage unit 120. For example, the information management unit 114 updates the user information DB 123 on the basis of information input from an operator of the server 4 and the user of the in-vehicle apparatus 1. Furthermore, when the latest travel history of the vehicle 100 is transmitted from the in-vehicle apparatus 1, the information management unit 114 updates the travel history DB 121 based on this latest travel history and reflects the latest travel history in the travel history DB 121.

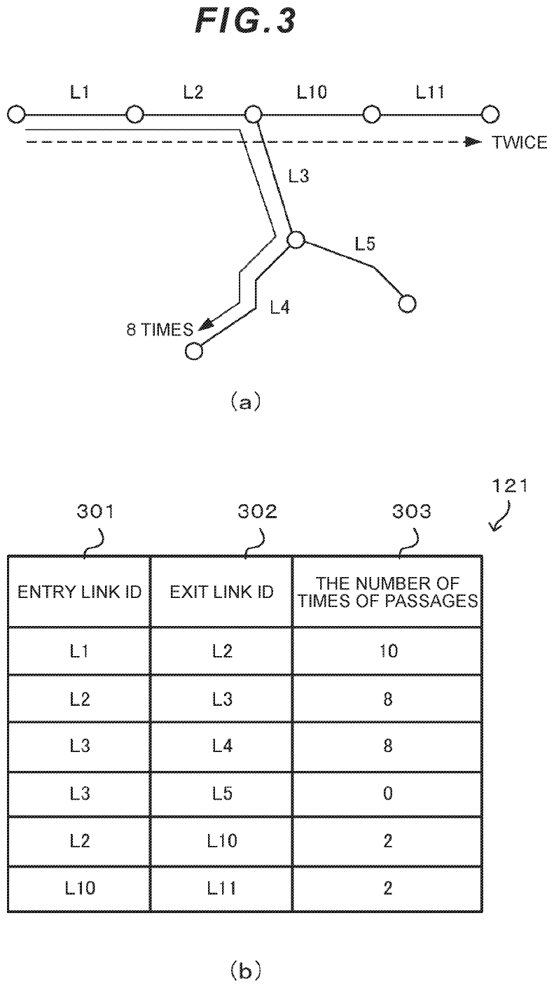

FIG. 3 is a diagram illustrating a data structure example of the travel history DB 121. FIG. 3A illustrates an example of link strings whose travel history is recorded in the travel history DB 121; and FIG. 3B illustrates a data structure example of the travel history DB 121 corresponding to the link strings in FIG. 3A.

The link strings illustrated in FIG. 3A are composed of links L1, L2, L3, L4, L5, L10, and L11. The link L1 connects to the link L2 and the link L2 connects the link L3 and L10. The link L3 connects to the link L4 and L5 and the link L10 connects to the link L11. Regarding the link strings having such a connection structure, let us assume that the number of times the vehicle 100 has passed through the links L1, L2, L10, and L11 in this sequential order is twice and the number of times the vehicle 100 has passed through the links L1, L2, L3, and L4 in this sequential order is eight times. Incidentally, let us assume that the vehicle 100 has never passed through the link L5.

In the above-described case, the travel history of the vehicle 100 is recorded in the travel history DB 121, for example, in the data structure illustrated in FIG. 3B. Regarding the data structure in FIG. 3B, the travel history DB 121 is configured of a plurality of records according to combinations of an entry link and an exit link of the link strings in FIG. 3A and has respective fields of an entry link ID 301, an exit link ID 302, and the number of times of passages 303.

The entry link ID 301 and the exit link ID 302 store the ID numbers of the entry link and the exit link, respectively, corresponding to each record in the travel history DB 121. The entry link is a link where the vehicle 100 passed first among two links which are mutually connected; and the exit link is a link where the vehicle 100 passed following the entry link. The number of times of passages 303 stores the number of times of passages by the vehicle 100 with respect to each combination of the entry link ID 301 and the exit link ID 302.

The travel history of each vehicle is recorded in the travel history DB 121 in the data structure described above with respect to a plurality of vehicles including the vehicle 100. Incidentally, the data structure of the travel history DB 121 illustrated in FIG. 3 is merely an example; and an arbitrary data structure can be used as long as the travel history of each vehicle can be recorded appropriately.

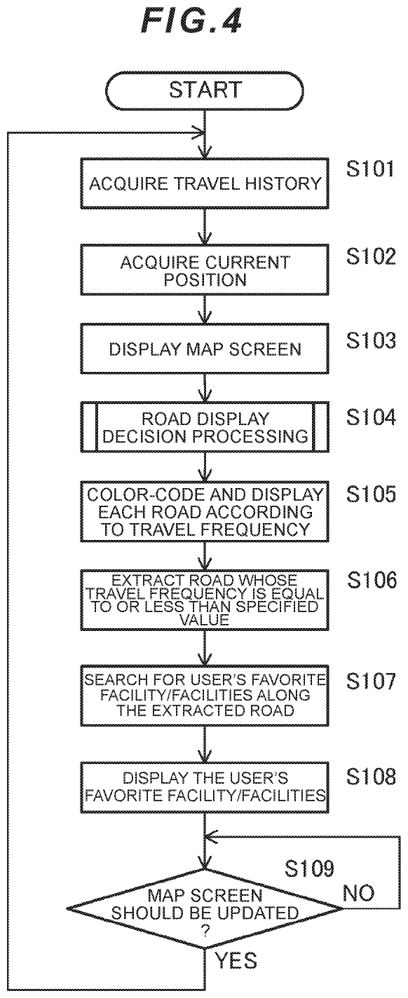

Next, the details of actions of the in-vehicle apparatus 1 and the server 4 when providing the user with information will be explained. FIG. 4 is a flowchart illustrating the actions of the in-vehicle apparatus 1 in the information provision system according to the first embodiment of the present invention. In this embodiment, the control unit 10 for the in-vehicle apparatus 1 starts a processing flow illustrated in FIG. 4, for example, when the in-vehicle apparatus 1 is activated.

In step S101, the control unit 10 acquires the travel history of the vehicle 100 from the server 4. Under this circumstance, the control unit 10 transmits a distribution request for the travel history to the server 4 by using the communication control unit 11. After receiving the distribution request from the in-vehicle apparatus 1, the server 4 has the distribution unit 112 acquire the travel history of the vehicle 100 from the travel history DB 121. Then, the server 4 distributes the acquired travel history to the in-vehicle apparatus 1. After receiving the travel history distributed from the server 4 in this way, the control unit 10 stores the received travel history in the travel history DB 22 and completes the processing in step S101.

In step 3102, the control unit 10 has the current position acquisition unit 13 acquire the current position from the current position detection unit 50.

In step S103, the control unit 10 has the display control unit 14 read the map information about a specified range around the current position, which was acquired in step S102, from the map DB 21 and displays the map screen on the display unit 30.

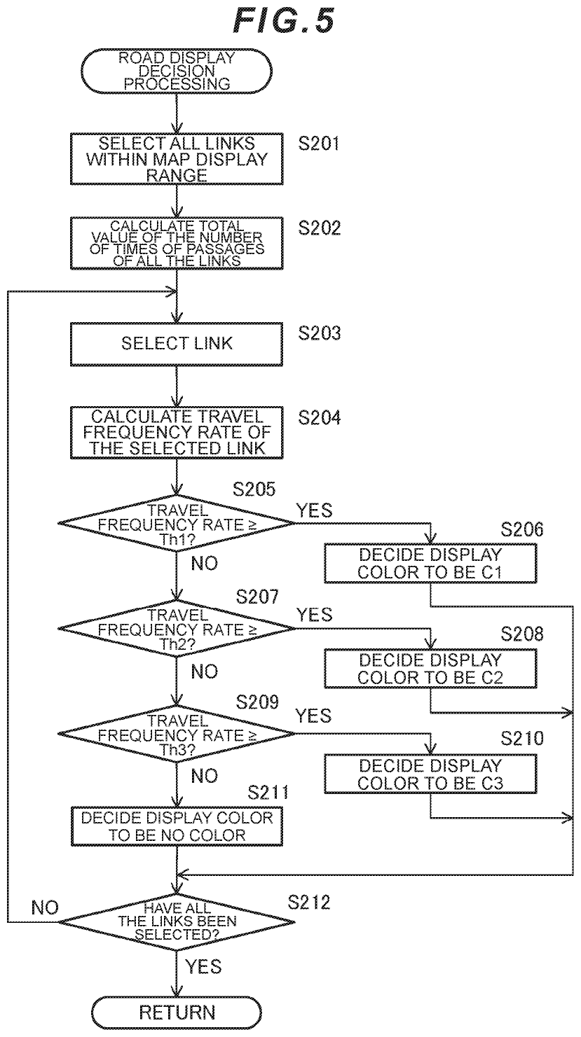

In step 3104, the control unit 10 has the road display decision unit 18 execute road display decision processing for deciding a display color of each road on the map screen displayed in step S103. Under this circumstance, the travel frequency of the vehicle 100 with respect to each road on the map screen is calculated based on the travel history DB 22 and the display color of each road is decided based on the calculated travel frequency. Incidentally, a specific processing sequence of step S104 will be explained later with reference to FIG. 5.

In step S105, the control unit 10 has the display control unit 14 color-code and display each road on the map screen in accordance with the display color decided by the road display decision processing in step S104. As a result of this processing in step S105, each road included within the display range of the map screen is displayed on the display unit 30 in the display form according to the travel frequency of the vehicle 100 based on the travel history DB 22.

In step S106, the control unit 10 extracts a road(s) whose travel frequency calculated by the road display decision processing in step S104 is equal to or less than a specified value from among the roads within the display range of the map screen displayed in step S103. Under this circumstance, for example, each road which is classified as having the lowest travel frequency in the color-coded display in step S105 is extracted.

In step S107, the control unit 10 has the facility search unit 19 search for the user's favorite facility/facilities along the road(s) extracted in step 3106. The user's favorite facility/facilities is a facility/facilities that matches/match the user's taste. Regarding the user's taste, for example, favorite information previously registered by the user can be recorded as part of the user information in the user information DB 122 of the server 4, so that this favorite information can be used to search for the user's favorite facility/facilities by acquiring this favorite information from the server 4. Alternatively, the user's taste may be determined based on, for example, the user's facility search history or the user's facility visit history judged based on the travel history DB 22. As a result of this processing in step S107, the facility/facilities that matches/match the user's taste and exists/exist along a road(s) within the display range of the map screen displayed in step S103 and with the travel frequency which is equal to or less than a specified value is/are found by the search.

In step 3108, the control unit 10 has the display control unit 14 display the user's favorite facility/facilities found by the search in step S107 on the map screen displayed in step 3103. Consequently, the map screen indicating the position(s) of the user's favorite facility/facilities along the road(s) with the travel frequency of the vehicle 100 which is equal to or less than the specified value is displayed on the display unit 30.

In step 3109, the control unit 10 judges whether the map screen displayed in step S103 should be updated or not. For example, when the display control unit 14 drew a map image regarding a specified drawing range larger than the display range of the map screen and each road within the drawing range has been color-coded and if the range of the map screen exceeds the drawing range according to any change of the current position and the user's scroll operation, scale change operation, and so on or a new road is included in objects displayed on the map screen, it is determined to update the map screen and the processing returns to step S101. Then, the updated map screen is displayed on the display unit 30 by executing the processing in step S101 and subsequent steps again. On the other hand, if they do not apply, it is determined to not update the map screen, the processing stays in step S109 and the judgment processing in step S109 is repeated.

Now, the processing sequence for the road display decision processing in step S104 will be explained. FIG. 5 is a flowchart of the road display decision processing executed by the road display decision unit 18.

In step S201, the road display decision unit 18 selects all links, that is, all roads included within the display range of the map screen displayed in step S103.

In step S202, the road display decision unit 18 calculates a total value of the number of times of passages of all the links selected in step S201 on the basis of the number of times of passages by the vehicle 100 with respect to each link recorded in the travel history DB 22.

In step S203, the road display decision unit 18 selects any one of the links included within the display range of the map screen displayed in step S103.

In step S204, the road display decision unit 18 calculates a travel frequency rate of the link selected in step S203 relative to all the links within the display range of the map screen. Under this circumstance, the travel frequency rate of the relevant link is calculated by calculating a ratio of the number of times of passages of the relevant link to the total value of the number of times of passages of all the links calculated in step S202 on the basis of the travel history DB 22. For example, since the total value of the number of times of passages of all the links in the link strings in FIG. 3A is 10 in the example of FIG. 3, the travel frequency rate of each of the links L3, L4 is calculated as 8/10=0.8. Similarly, the travel frequency rate of each of the links L10, L11 is calculated as 2/10=0.2.

In step S205, the road display decision unit 18 judges whether or not the travel frequency rate calculated in step S204 is equal to or more than a specified threshold value Th1. If the travel frequency rate is equal to or more than Th1, the processing proceeds to step S206, the display color of the relevant link is decided as a specified color C1 in step S206, and then the processing proceeds to step S212. On the other hand, if the travel frequency rate is less than Th1, the processing proceeds to step S207.

In step S207, the road display decision unit 18 judges whether or not the travel frequency rate calculated in step S204 is equal to or more than a specified threshold value Th2 (where Th2<Th1). If the travel frequency rate is equal to or more than Th2, the processing proceeds to step S208, the display color of the relevant link is decided as a specified color C2 in step S208, and then the processing proceeds to step S212.

On the other hand, if the travel frequency rate is less than Th2, the processing proceeds to step S209.

In step S209, the road display decision unit 18 judges whether or not the travel frequency rate calculated in step S204 is equal to or more than a specified threshold value Th3 (where Th3<Th2). If the travel frequency rate is equal to or more than Th3, the processing proceeds to step S210, the display color of the relevant link is decided as a specified color C3 in step S210, and then the processing proceeds to step S212.

On the other hand, if the travel frequency rate is less than Th3, the processing proceeds to step S211.

In step S211, the road display decision unit 18 decides the display color of the relevant link as “No Color.” The link whose display color is decided here as “No Color” is not color-coded displayed in step S105 in FIG. 4 and is displayed as the original map screen. Incidentally, a specified display color C4 which is different from the aforementioned colors C1 to C3 may be set to the relevant link without deciding the display color as “No Color.”

In step S212, the road display decision unit 18 judges whether or not all the links included within the display range of the map screen have been selected in step S203.

If any link(s) which has not been selected exists within the display range of the map screen, the processing returns to step S203, any one of the unselected links is selected in step S203 and then the processing in step S204 and subsequent steps is executed on the relevant link. On the other hand, if all the links included within the display range of the map screen have been selected, the road display decision processing illustrated in FIG. 5 is terminated.

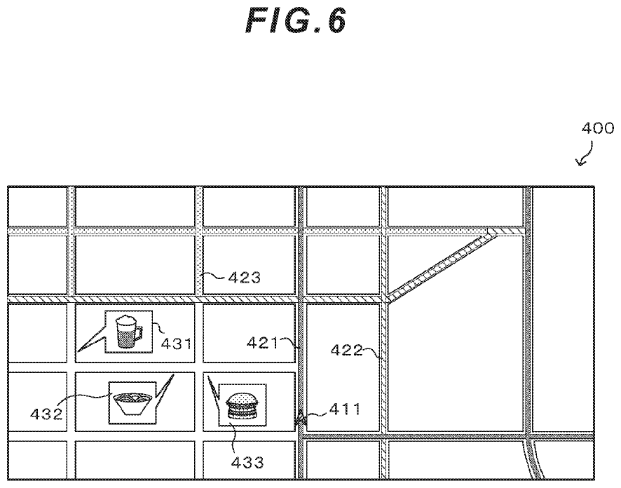

Next, a specific example of the map screen displayed on the display unit 30 for the in-vehicle apparatus 1 by the processing in FIG. 4 will be explained with reference to FIG. 6. FIG. 6 is a diagram illustrating an example of the map screen according to the first embodiment of the present invention.

A map screen 400 in FIG. 6 displays a map around a current position 411 and each road is displayed with a display color 421 to 423 according to the travel frequency of the vehicle 100. The display color 421 indicates a road with the highest travel frequency and corresponds to the display color C1 which is set in step S206 in FIG. 5.

The display color 422 indicates a road with the second highest travel frequency and corresponds to the display color C2 which is set in step S208 in FIG. 5. The display color 423 indicates a road with the third highest travel frequency and corresponds to the display color C3 which is set in step S210 in FIG. 5. Incidentally, a road with the lowest travel frequency is displayed without coloring on the map screen 400.

Furthermore, the map screen 400 in FIG. 6 displays facility icons 431 to 433 indicating the user's favorite facilities. These facility icons 431 to 433 are displayed in step S108 in FIG. 4 and respectively represent the facilities which match the user's taste and exist along roads with the lowest travel frequency, that is, roads without coloring on the map screen 400.

According to the first embodiment of the present invention described above, the following operational advantages are obtained.

(1) The in-vehicle apparatus 1 mounted in the vehicle 100 includes: the travel history DB 22 in which the travel history of the vehicle 100 with respect to each road is recorded; and the display control unit 14 that has the display unit 30 display the map screen 400. The display control unit 14 has the display unit 30 display each road included within the display range of the map screen 400 in the display form according to the travel frequency of the vehicle 100 on the basis of the travel history DB 22. Consequently, the user can be informed of the past travel frequency of the roads existing within the display range of the map.

(2) The in-vehicle apparatus 1 further includes the road display decision unit 18 that calculates the travel frequency of the vehicle 100 with respect to each road included within the display range of the map screen 400 on the basis of the travel history DB 22 and decides the display form of each road on the basis of the calculated travel frequency (step S104 in FIG. 4). The display control unit 14 has the display unit 30 display each road included within the display range of the map screen 400 in the display form decided by the road display decision unit 18 (step S105). Consequently, it is possible to appropriately decide the display form of each road according to the travel frequency of the vehicle 100 and display the decided display form on the map screen.

(3) The road display decision unit 18 calculates the travel frequency by calculating a total value of the number of times of passages regarding each road included within the display range of the map screen 400 in the travel history DB 22 (step S202 in FIG. 5) and calculating a ratio of the number of times of passages regarding each road to this total value (step S204 in FIG. 5). Consequently, it is possible to appropriately calculate the travel frequency of each road regardless of whether the number of times of passages of all the roads existing within the display range of the map is large or not.

(4) The in-vehicle apparatus 1 further includes the facility search unit 19 that searches for a facility/facilities included within the display range of the map screen 400 on the basis of the travel frequency of the vehicle 100 (steps S106, S107 in FIG. 4). The display control unit 14 has the display unit 30 display the map screen 400 indicating the position(s) of the facility/facilities found by the search by the facility search unit 19 (step S108). Consequently, it is possible to propose a recommended facility/facilities according to the travel frequency of the vehicle 100 to the user.

(5) The facility search unit 19 searches, in step S106 and S107 in FIG. 4, for a facility/facilities that matches/match the user's taste and exists/exist along a road which exists within the display range of the map screen 400 and regarding which the travel frequency of the vehicle 100 is equal to or less than a specified value.

Consequently, it is possible to propose, for example, a facility/facilities existing in an area where the user has not visited very often in the past, as a recommended facility/facilities and to invoke the user's new discovery.

(6) The information provision system includes the in-vehicle apparatus 1 mounted in the vehicle 100, and the server 4. The in-vehicle apparatus 1 includes: the communication control unit 11 that receives the travel history of the vehicle 100 with respect to each road, wherein the travel history is transmitted from the server 4; and the display control unit 14 that has the display unit 30 display the map screen 400. The server 4 includes: the travel history DB 22 in which the travel history of a plurality of vehicles including the vehicle 100 is recorded with respect to each road; and the communication control unit 11 that transmits the travel history of the vehicle 100 with respect to each road on the basis of the travel history DB 22. The display control unit 14 has the display unit 30 display each road included within the display range of the map screen 400 in the display form according to the travel frequency of the vehicle 100 on the basis of the received travel history. Consequently, the user can be informed of the past travel frequency of the roads existing within the display range of the map by using the travel history of the vehicle 100 which is downloaded and acquired from the server 4.

### Second Embodiment

Next, a second embodiment of the present invention will be explained. The aforementioned first embodiment has described the example where a facility/facilities that matches/match the user's taste and exists/exist along a road(s) with the lowest travel frequency is/are searched for and the facility/facilities found by the search is/are displayed on the map screen. In this embodiment, an explanation will be provided about an example where a facility/facilities which is/are different from the above-described facility/facilities and the facility/facilities found by the search is/are displayed on the map screen. Incidentally, the configuration of the information provision system according to this embodiment and the configuration of the in-vehicle apparatus 1 and the server 4 are respectively the same as those in FIG. 1 and FIG. 2 as explained with regard to the first embodiment. Therefore, an explanation of these configurations has been omitted in the following explanation.

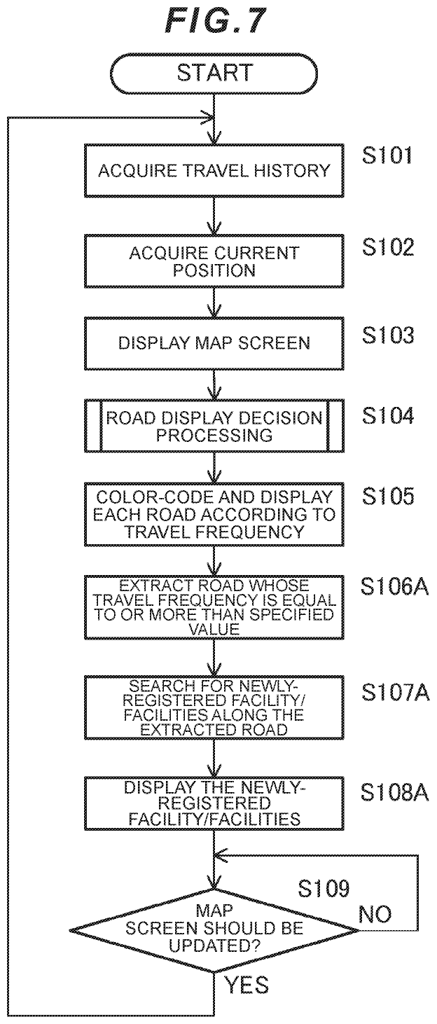

FIG. 7 is a flowchart illustrating actions of the in-vehicle apparatus 1 in the information provision system according to the second embodiment of the present invention. In this embodiment, for example, when the in-vehicle apparatus 1 is activated, the control unit 10 for the in-vehicle apparatus 1 starts a processing flow illustrated in FIG. 7.

Incidentally, regarding the processing flow in FIG. 7, the same step numbers as those in FIG. 4 are assigned to processing steps with the same content as that of the processing flow in FIG. 4 according to the first embodiment.

In each of steps S101 to S105 and S109, the control unit 10 executes the same processing as that explained in the first embodiment.

In step S106A, the control unit 10 extracts a road(s) whose travel frequency calculated by the road display decision processing in step S104 is equal to or more than a specified value, from the roads existing within the display range of the map screen displayed in step S103. Under this circumstance, for example, each road which is classified as having the highest travel frequency in the color-coded display in step S105 is extracted.

In step S107A, the control unit 10 has the facility search unit 19 search for a newly-registered facility along the road extracted in step S106A. Under this circumstance, the control unit 10 makes a distribution request for, for example, facility information about the newly-registered facility to the server 4 and acquires the facility information distributed from the server 4 in response to this request. The facility search unit 19 can execute the processing in step S107A by using the thus-acquired facility information. As a result of this processing in step S107A, the newly-registered facility existing along the road within the display range of the map screen displayed in step S103 and with the travel frequency equal to or more than the specified value is found by the search.

In step S108A, the control unit 10 has the display control unit 14 display the newly-registered facility found by the search in step S107A on the map screen displayed in step S103. Consequently, the map screen indicating the position of the newly-registered facility existing along the road with the travel frequency of the vehicle 100 which is equal to or more than the specified value is displayed on the display unit 30.

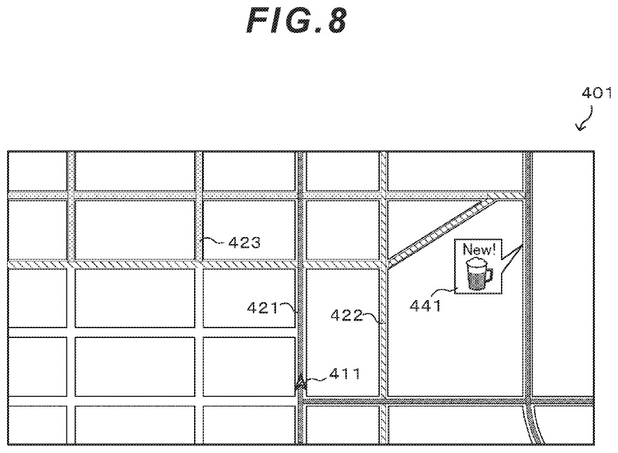

FIG. 8 is a diagram illustrating an example of a map screen according to the second embodiment of the present invention. A map screen 401 in FIG. 8 displays a map around the current position 411 in the same manner as the map screen 400 in FIG. 6 explained in the first embodiment and each road is displayed in the display color 421 to 423 according to the travel frequency of the vehicle 100. Furthermore, with the map screen 401 in FIG. 8, a facility icon 441 indicating a newly-registered facility is displayed. This facility icon 441 is displayed in step S108A in FIG. 7 and represents a newly-registered facility along a road with the highest travel frequency, that is, a road displayed with the display color 421 on the map screen 401.

Incidentally, with the map screen 401 in FIG. 8, the newly-registered facility existing along the road with the highest travel frequency is set as a display object of the facility icon 441; however, as long as the travel frequency of the relevant road is equal to or more than a specified value, a newly-registered facility/facilities existing along other roads may be set as the display object(s). Furthermore, a facility/facilities other than the newly-registered facility/facilities may be set as the display object(s) of the facility icon 441. For example, it is also possible to judge the user's facility visit history based on the travel history DB 22 and set a facility which matches the user's taste, but where the user has never visited in the past, as the display object of the facility icon 441.

According to the above-explained second embodiment of the present invention, the facility search unit 19 searches for a newly-registered facility existing along a road within the display range of the map screen 401 and with the travel frequency of the vehicle 100 which is equal to or more than the specified value in steps S106A and S107A in FIG. 7. Consequently, it is possible to propose, for example, a newly-opened facility along a road where the user often passes, as a recommended facility and invoke the user's new discovery.

### Third Embodiment

Next, a third embodiment of the present invention will be explained. In this embodiment, an explanation will be provided about an example where the display form of each road is decided by a method different from the methods in the first and second embodiments. Incidentally, the configuration of the information provision system according to this embodiment and the configuration of the in-vehicle apparatus 1 and the server 4 are respectively the same as those in FIG. 1 and FIG. 2 as explained with regard to the first embodiment. Therefore, an explanation of these configurations has been omitted in the following explanation.

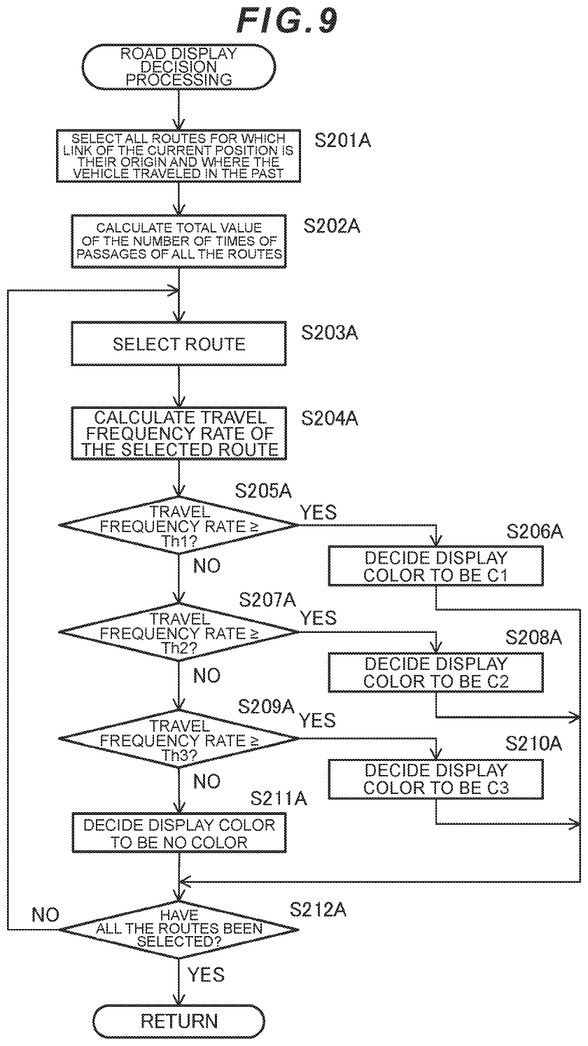

FIG. 9 is a flowchart illustrating a processing sequence for road display decision processing executed by the road display decision unit 18 for the in-vehicle apparatus 1 in the information provision system according to the third embodiment of the present invention. In this embodiment, the road display decision unit 18 for the in-vehicle apparatus 1 executes the road display decision processing in accordance with the processing flow illustrated in FIG. 9 in step S104 in FIG. 4 or FIG. 7. Incidentally, in other processing steps in FIG. 4 or FIG. 7, the same processing as that explained in the first embodiment and the second embodiment, respectively, is executed.

In step S201A, the road display decision unit 18 selects all routes which include a link corresponding to the current position acquired in step S102 as their origin and where the vehicle 100 traveled in the past. Under this circumstance, all combinations of links where the vehicle 100 traveled in the past and which are sequentially connected from the link corresponding to the current position in a traveling direction of the vehicle 100, from among the links included within the display range of the map screen displayed in step S103, are selected as all the routes which include the current position as their origin and where the vehicle 100 traveled in the past.

In step S202A, the road display decision unit 18 calculates a total value of the number of times of passages of all the routes selected in step S201A on the basis of the number of times of passages by the vehicle 100 with respect to each link recorded in the travel history DB 22. Under this circumstance, the total value of the number of times of passages of all the routes is calculated by counting the number of times of passages by the vehicle 100 which is recorded in the travel history DB 22 with respect to each combination of an entry link and an exit link, which are mutually connected, and calculating the total value of the counted number of times of passages.

In step S203A, the road display decision unit 18 selects any one of all the routes selected in step S201A which include the current position as their origin and where the vehicle 100 traveled in the past.

In step S204A, the road display decision unit 18 calculates the travel frequency rate of the route selected in step S203A relative to all the routes which include the current position as their origin and where the vehicle 100 traveled in the past. Under this circumstance, the travel frequency rate of the relevant route is calculated by calculating a ratio of the number of times of passages of the relevant route to the total value of the number of times of passages of all the routes calculated in step S202A.

In steps S205A to S211A, the display color for each link of the route selected in step S203A is decided based on the travel frequency rate calculated in step S204A by a processing sequence similar to that of steps S205 to S211 in FIG. 5. Specifically speaking, if the travel frequency rate is equal to or more than a specified threshold value Th1, the display color of each link of the relevant route is decided as a specified color C1 in step S206A; and if the travel frequency rate is equal to or more than a specified threshold value Th2, the display color of each link of the relevant route is decided as a specified color C2 in step S208A; and if the travel frequency rate is equal to or more than a specified threshold value Th3, the display color of each link of the relevant route is decided as a specified color C3 in step S210A. Furthermore, if the travel frequency rate is less than a threshold value Th3, the display color of each link of the relevant route is decided as “No Color” or a specified display color C4 in step S211A. Under this circumstance, the respective threshold values of Th1, Th2, and Th3 mentioned above may be the same as those explained in the first embodiment or may be different values which satisfy the relationship of Th3<Th2<Th1. When any one of the display colors is decided for each link of the selected route in this way, the processing proceeds to step S212A.

Incidentally, if any display color for the links of the relevant route has already been decided as a display color for links of other routes when deciding the display color of each link of the route in steps S205A to S211A, either the display color which is decided this time or the display color which has already been decided should preferably be adopted. For example, if these display colors are different, the display color with a higher travel frequency rate can be adopted; and if these display colors are the same, that display color can be adopted. Alternatively, both the display colors may be adopted. In this case, for example, when color-coding and displaying each road according to the travel frequency in step S105 in FIG. 4 or FIG. 7, both display colors may be displayed together for the relevant link.

In step S212A, the road display decision unit 18 judges whether or not all the routes which include the current position as their origin and where the vehicle 100 traveled in the past have been selected in step S203A. If any unselected route(s) exists among all the routes which were to be selected in step S201A, which include the current position as their origin, and where the vehicle 100 traveled in the past, the processing returns to step S203A, any one of the unselected routes in step S203A is selected, and then the processing in step S204A and subsequent steps is executed on the relevant route.

On the other hand, if all the routes which were to be selected in step S201A, which include the current position as their origin, and where the vehicle 100 traveled in the past have been selected, the road display decision processing illustrated in FIG. 9 is terminated.

When the above-explained road display decision processing is executed by the road display decision unit 18 in step S104, the display control unit 14 color-codes and displays each road on the map screen in accordance with the display colors decided by this road display decision processing in subsequent step S105 in FIG. 4 or FIG. 7. As a result of this processing in step S105, each road included within the display range of the map screen is displayed on the display unit 30 in the display form according to the travel frequency of the vehicle 100 with respect to all the routes where the vehicle 100 traveled in the past, on the basis of the travel history DB 22.

According to the above-explained third embodiment of the present invention, the display control unit 14 has the display unit 30 display each road included within the display range of the map screen in the display form according to the travel frequency of the vehicle 100 with respect to all the routes where the vehicle 100 traveled in the past, on the basis of the travel history DB 22. Specifically speaking, the in-vehicle apparatus 1 further includes the road display decision unit 18 that: calculates the travel frequency of the vehicle 100 with respect to each route which includes the current position of the vehicle 100 as its origin and where the vehicle 100 traveled in the past, on the basis of the travel history DB 22 (step S204A); and decides the display form of each road based on the calculated travel frequency (steps S205A to S211A). Under this circumstance, the road display decision unit 18 calculates the travel frequency by counting the number of times of passages in the travel history DB 22 with respect to each combination of an entry link and an exit link, which are mutually connected, and calculating the total value of the counted number of times of passages (step S202A) and calculating a ratio of the number of times of passages of each route to the above-calculated total value (step S204A). The display control unit 14 has the display unit 30 display each road included within the display range of the map screen in the display form decided by the road display decision unit 18 (step S105). Consequently, it is possible to appropriately decide the display form of each road and display it on the map screen in consideration of linkage between the links in the travel history of the vehicle 100 in the past.

Incidentally, the above-explained embodiment has described the example where the in-vehicle apparatus 1 acquires the travel history of the vehicle 100 from the server 4; however, the travel history of the vehicle 100 may be stored in the in-vehicle apparatus 1 in advance. In this case, the in-vehicle apparatus 1 may be designed to not connect to the server 4. Specifically speaking, in this case, the server 4 is unnecessary and the present invention can be implemented by only the in-vehicle apparatus 1.

Furthermore, the above-explained embodiment has described the screen examples, the map screens 400, 401, which do not include information about the automatic driving of the vehicle 100; however, the information about the automatic driving may be included and displayed in the map screen. For example, an automatic driving history of the vehicle 100 is recorded in the in-vehicle apparatus 1 and/or the server 4 with respect to each road and an automatic driving frequency of the vehicle 100 with respect to each road included within the display range of the map screen is calculated based on this automatic driving history for each road. Then, the display form of each road is decided according to the calculated automatic driving frequency by a method similar to that explained in the embodiment and is displayed on the map screen. By doing so, the user can be informed of the past automatic driving frequency of roads existing within the display range of the map. Besides this, it is possible to present the information about the automatic driving of the vehicle 100 to the user in an arbitrary manner.

The above-explained embodiment has described the example where each road included within the display range of the map screen is color-coded in four levels and displayed according to the travel frequency; however, the present invention is not limited to this example and each road can be color-coded in an arbitrary number of levels and displayed. Furthermore, the difference in the travel frequency of each road may be made identifiable by, for example, changing shades or brightness of colors, line thickness or types, and a blinking rate according to the travel frequency instead of color-coding and displaying each road. Specifically speaking, as long as each road included within the display range of the map screen is displayed in a display form according to the travel frequency of the vehicle, such display is included within the application scope of the present invention.

The above-explained embodiment has described the example where the map screens 400, 401 on which the roads are color-coded according to the travel frequency of the vehicle 100 are displayed on the display unit 30 included in the in-vehicle apparatus 1; however, the roads may be color-coded and displayed on an external display device connected to the in-vehicle apparatus 1. For example, an HUD (Head-Up Display), projection mapping onto a road surface, a wearable display device such as a spectacle-type display, or an aerial imaging display can be used as the external display device. Furthermore, a display of, for example, a smartphone, a tablet PC, or a notebook PC can also be used as the external display device.

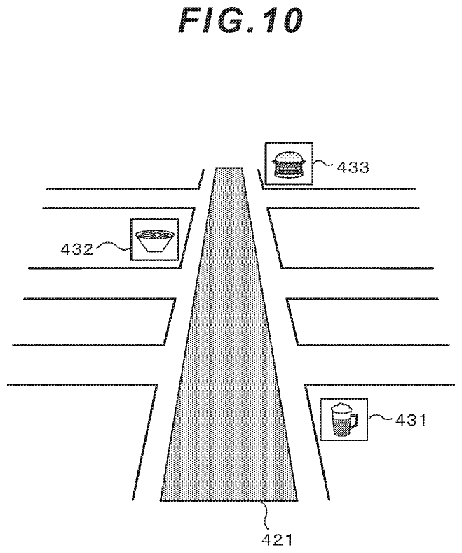

FIG. 10 is a diagram illustrating an example where the roads are color-coded and displayed via a HUD or projection mapping. Referring to FIG. 10, the display color 421 according to the travel frequency is displayed by making it correspond to actual roads and the facility icons 431 to 433 indicating the user's favorite facilities are displayed by making them correspond to the positions of actual facilities. By using such display, it is also possible to notify the user of the travel frequency for each road.

The above-described embodiments and variations are merely examples. The present invention is not limited to the above-described embodiments unless they impair the features of the present invention; and other aspects which can be thought of within the scope of the technical idea of the present invention are also included within the scope of the present invention.

The disclosure of the following priority basic application is hereby incorporated by reference.

Japanese Patent Application No. 2017-240003 (filed on Dec. 14, 2017)

### REFERENCE SIGNS LIST

1: in-vehicle apparatus
2: communication terminal
3: communication line network
4: server
5: front camera
6: side camera
7: vehicle control apparatus
10: control unit
11: communication control unit
12: interface control unit
13: current position acquisition unit
14: display control unit
15: vehicle information acquisition unit
16: vehicle control unit
17: route estimation unit
18: road display decision unit
19: facility search unit
20: storage unit
21: map DB
22: travel history DB
30: display unit
40: operation input unit
50: current position detection unit
100: vehicle
110: control unit
111: communication control unit
112: distribution unit
113: facility information acquisition unit
114: information management unit
120: storage unit
121: travel history DB
122: facility information DB
123: user information DB

1. An in-vehicle apparatus mounted in a vehicle, comprising:
a travel history database in which a travel history of the vehicle is recorded with respect to each road; and
a display control unit that has a display unit display a map screen,
wherein the display control unit has the display unit display each road included within a display range of the map screen in a display form according to a travel frequency of the vehicle on the basis of the travel history database.

2. The in-vehicle apparatus according to claim 1,
further comprising a road display decision unit that calculates the travel frequency of the vehicle with respect to each road on the basis of the travel history database and decides the display form of each road on the basis of the calculated travel frequency,
wherein the display control unit has the display unit display each road in the display form decided by the road display decision unit.

3. The in-vehicle apparatus according to claim 2,
wherein the road display decision unit calculates the travel frequency by calculating a total value of the number of times of passages regarding each road in the travel history database and calculating a ratio of the number of times of passages regarding each road to the total value.

4. The in-vehicle apparatus according to claim 1,
further comprising a facility search unit that searches for a facility included within the display range of the map screen on the basis of the travel frequency,
wherein the display control unit has the display unit display the map screen indicating a position of the facility found by the search by the facility search unit.

5. The in-vehicle apparatus according to claim 4,
wherein the facility search unit searches for a facility that matches a user's taste and exists along a road within the display range of the map screen and regarding which the travel frequency is equal to or less than a specified value.

6. The in-vehicle apparatus according to claim 4,
wherein the facility search unit searches for a newly-registered facility that exists along a road within the display range of the map screen and regarding which the travel frequency is equal to or more than a specified value.

7. The in-vehicle apparatus according to claim 1,
wherein the display control unit has the display unit display each road included within the display range of the map screen on the basis of the travel history database in the display form according to the travel frequency of the vehicle with respect to all routes where the vehicle traveled in the past.

8. The in-vehicle apparatus according to claim 7,
further comprising a road display decision unit that calculates the travel frequency of the vehicle with respect to each route whose origin is a current position of the vehicle and where the vehicle traveled in the past, on the basis of the travel history database and decides the display form of each road on the basis of the calculated travel frequency,
wherein the display control unit has the display unit display each road in the display form decided by the road display decision unit.

9. The in-vehicle apparatus according to claim 8,
wherein the road display decision unit calculates the travel frequency by counting the number of times of passages in the travel history database with respect to each combination of an entry link and an exit link, which are mutually connected, calculating a total value of the counted number of times of passages, and calculating a ratio of the number of times of passages for each route to the total value.

10. An information provision system equipped with an in-vehicle apparatus mounted in a vehicle, and a server,
the in-vehicle apparatus comprising:
an in-vehicle communication control unit that receives a travel history of the vehicle with respect to each road, wherein the travel history is transmitted from the server; and
a display control unit that has a display unit display a map screen, and
the server comprising:
a travel history database in which a travel history of a plurality of vehicles including the vehicle is recorded with respect to each road; and
a server communication control unit that transmits the travel history of the vehicle with respect to each road on the basis of the travel history database,
wherein the display control unit has the display unit display each road included within a display range of the map screen in a display form according to a travel frequency of the vehicle on the basis of the travel history.

11. An information presentation method for recording a travel history of a vehicle with respect to each road and having a display unit mounted in the vehicle display a map screen indicating each road in a display form according to a travel frequency of the vehicle on the basis of the travel history.

12. The information presentation method according to claim 11,
wherein an in-vehicle apparatus mounted in the vehicle is caused to:
calculate the travel frequency of the vehicle with respect to each road on the basis of the travel history;
decide the display form of each road on the basis of the calculated travel frequency; and
have the display unit display each road in the decided display form.

13. The information presentation method according to claim 12,
wherein the in-vehicle apparatus calculates the travel frequency by calculating a total value of the number of times of passages regarding each road in the travel history and calculating a ratio of the number of times of passages regarding each road to the total value.

14. The information presentation method according to claim 11,
wherein an in-vehicle apparatus mounted in the vehicle is caused to:
search for a facility included within a display range of the map screen on the basis of the travel frequency; and
have the display unit display the map screen indicating a position of the facility found by the search.

15. The information presentation method according to claim 14,
wherein the in-vehicle apparatus searches for a facility that matches a user's taste and exists along a road within the display range of the map screen and regarding which the travel frequency is equal to or less than a specified value.

16. The information presentation method according to claim 14,
wherein the in-vehicle apparatus searches for a newly-registered facility that exists along a road within the display range of the map screen and regarding which the travel frequency is equal to or more than a specified value.

17. The information presentation method according to claim 11,
wherein each road included within a display range of the map screen is displayed on the display unit on the basis of the travel history in the display form according to the travel frequency of the vehicle with respect to all routes where the vehicle traveled in the past.

18. The information presentation method according to claim 17,
wherein an in-vehicle apparatus mounted in the vehicle is caused to:
calculate the travel frequency of the vehicle with respect to each route whose origin is a current position of the vehicle and where the vehicle traveled in the past, on the basis of the travel history;
decide the display form of each road on the basis of the calculated travel frequency; and
have the display unit display each road in the decided display form.

19. The information presentation method according to claim 18,
wherein the in-vehicle apparatus calculates the travel frequency by counting the number of times of passages in the travel history with respect to each combination of an entry link and an exit link, which are mutually connected, calculating a total value of the counted number of times of passages, and calculating a ratio of the number of times of passages for each route to the total value.
